(19) United States
(12) Patent Application Publication
(10) Pub. No.: US 2009/0078525 A1
(43) Pub. Date: Mar. 26, 2009

(54) Method and Apparatus For Limiting Wheel End Clutch Ring Travel

(75) Inventors: Jeffrey W. Schumacher, North Canton, OH (US); Steven P. Russell, Uniontown, OH (US); Mircea Gradu, Auburn Hills, MI (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: THE TIMKEN COMPANY, Canton, OH (US)

(21) Appl. No.: 12/238,630

(22) Filed: Sep. 26, 2008

Related U.S. Application Data
(60) Provisional application No. 60/975,404, filed on Sep. 26, 2007.

(51) Int. Cl. F16D 11/10

(52) U.S. Cl. 192/69.41

(57) ABSTRACT

A travel limiter associated with a wheel end adapted to selectively engage and disengage a drive shaft via a sliding clutch ring. The travel limiter operatively disposed on a coupler of the wheel end and configured to limit axial displacement of the sliding clutch ring towards the wheel assembly when engaging the drive shaft.

### CROSS-REFERENCE TO RELATED APPLICATIONS

The present application is related to, and claims priority from, U.S. Provisional Patent Application Ser. No. 60/975,404 filed on Sep. 26, 2007, and which is herein incorporated by reference.

### STATEMENT REGARDING FEDERALLY SPONSORED RESEARCH

Not Applicable.

### BACKGROUND OF THE INVENTION

The present invention is related generally to the assembly of an integrated wheel end which includes a movable clutch ring for selective engagement between a disengaged position and an engaged position for transferring driving torque from a drive shaft to the wheel end, and in particular, to a coupler ring abutment feature configured to limit travel of the movable clutch ring relative to a coupler on the wheel end during assembly with the drive shaft.

In vehicles which have the ability to selectively switch between two-wheel and four-wheel drive, a means must be provided to connect and disconnect the part-time drive wheels from the engine's drive shaft. One mechanism to accomplish this may be provided by a mechanical connect/disconnect at the integrated wheel ends for the part-time drive wheels. In general, as shown in FIG. 1, a drive component of an integrated wheel end 10, referred to as a coupler 100, has external splines 102 which are in close axial relationship to a driven drive shaft 20 having matching external splines. A clutch ring 200 having internal splines 202 which match the external splines 102 of the coupler and the drive shaft 20 is disposed in engagement with the external splines 22 of the drive shaft 20 and may be axially displaced for sliding engagement with the external splines 102 of the coupler 100 to selectively couple and decouple the drive shaft 20 from the integrated wheel end 10. A traditional actuating mechanism, including a shift fork 30, as seen in FIG. 1, is engaged with an annular groove 204 in the outer peripheral edge of the clutch ring 200 to provide for mechanical movement of the clutch ring into and out of splined engagement with the coupler 100. Axial movement of the shift fork 30 during engagement is limited by an abutting relationship with a knuckle surface 40 of the integrated wheel end 10.

As can be further seen in FIG. 1, the actuating mechanism or shift fork 30 is fixedly mounted to the knuckle of a vehicle. An air line is coupled to a port 32 of the actuating mechanism 30, and to an air source, such as an intake manifold. As shown, an L-shaped section 34 of the fork 30 fits in the annular groove 204 of the clutch ring 200. The internal clutch teeth 202 of the clutch ring 200 are permanently engaged with clutch teeth 22 on axle shaft 20. The coupler 100 is mounted on a wheel hub spindle 50 such as with internal splines of the coupler 100 engaged with external splines of the wheel hub spindle 50, such that the coupler 100 is in splined engagement with the hub spindle 50 and rotates with the hub spindle 50. To retain the coupler 100 in place, the end face of the wheel hub spindle 50 may be roll formed around the inboard edge of the coupler 100. The wheel hub spindle 50 is in turn, coupled to the knuckle through a bearing assembly 12 which includes inner races 14, outer races 16 secured to the knuckle, and rolling elements 18 disposed between the races.

As a conventional integrated wheel end is assembled, there is a possibility that the external splines on the movable clutch ring or torque disconnect feature may not align with the external splines on the drive shaft. If this happens, and a retention nut on the drive shaft is tightened, the shift fork holding the movable clutch ring in place may fracture or deform in response to the axial forces applied to the movable clutch ring by the ends of the drive shaft splines.

Specifically, as the integrated wheel end is being assembled to the drive shaft, the clutch teeth of the clutch ring and the coupler on the wheel end are aligned, but the drive shaft clutch teeth may be out of alignment with the clutch teeth of the clutch ring. In this instance, forces applied to the clutch ring by the drive shaft have a tendency to press against the ends of the splines of the clutch ring, while the shift fork is in abutting engagement with a knuckle of the integrated wheel end. Since the base portion of the shift fork is abutting against the knuckle, axial forces applied to the axially unrestricted clutch ring impart stresses across the radial dimension of the shift fork which can potentially cause breakage or cracking of the shift fork during installation.

Conventionally, prior art couplers 100 are manufactured to include an annular lip 104 on the outer diameter to limit the axial travel of the clutch ring 200 relative to the coupler 100. The annular lip 104 is formed on the coupler during manufacturing of the coupler 100. FIGS. 2A, 2B, and 2C illustrate various prior art coupler designs that include an annular lip 104 that is illustrated as a flanged edge to the coupler 100. FIG. 2D illustrates a prior art coupler design in which the annular lip 104 is replaced by a separate snap ring 106 seated within an annular groove ground into the external diameter of the external splines 102.

Accordingly, it would be advantageous to provide an alternative and simplified means for restricting or limiting axial movement of the clutch ring during assembly of the integrated wheel end to the drive shaft, whereby axial forces applied to the clutch ring by the drive shaft during tightening of a retention nut or other attachment means do not impart significant stresses or moments across the radial dimension of the shift fork which may result in damage there to. It would be further advantageous to provide such a means which does not require redesign or redevelopment of existing integrated wheel ends, and which does not result in a weakening of the various splined components.

### BRIEF SUMMARY OF THE INVENTION

Briefly stated, the present disclosure provides a travel limiter for restricting or limiting axial movement of a clutch ring having internal splines during assembly of an integrated wheel end to a drive shaft, whereby axial forces applied to the clutch ring by the drive shaft during tightening of a retention nut or other attachment means do not impart significant stresses or moments across the radial dimension of an associated shift fork, which may result in damage there to. The annular travel limiter is a discrete component which is cooperatively associated with a coupler ring of the integrated wheel end, and which is configured to limit the axial travel of the clutch ring when engaging external splines of the coupler ring.

In one embodiment of the present disclosure, the coupler ring of the integrated wheel end includes an annular groove disposed about the circumference of the outboard face of the coupler ring. The annular travel limiter is seated within the annular groove, flush with the outboard face of the coupler ring. The axial depth of the annular groove, and correspondingly, the axial width of the travel limiter, is selected to ensure that the clutch ring axial travel from the inboard face towards the outboard face, during engagement with the coupler ring is limited to a selected axial distance by interference between the internal splines of the clutch ring and an inboard edge of the travel limiter.

In a next embodiment of the present disclosure, the coupler ring of the integrated wheel end includes an annular groove disposed about the circumference of the outboard face of the coupler ring. The annular travel limiter has an “L” shaped cross-section, with one portion seated within the annular groove, flush with the outboard face of the coupler ring, and a second axially extending portion disposed in the inboard direction over the outer circumference of the coupler external splines. During engagement with the coupler ring, axial travel of the clutch ring is limited to a selected axial distance by interference between the internal splines of the clutch ring and an inboard edge of the travel limiter axial extension.

In a next embodiment of the present disclosure, the annular travel limiter is disposed about the outer circumference of the coupler ring, adjacent to the outboard face thereof. The annular travel limiter includes at least one radially inwardly projecting tooth, configured to mesh with the external splines of the coupler ring. During engagement with the coupler ring, axial travel of the clutch ring is limited to a selected axial distance by interference between the outboard face and internal splines of the clutch ring and an inboard edge of the travel limiter disposed about the coupler ring.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a cross-section view of a prior art wheel end assembly illustrating the wheel end engaged with the drive shaft;

FIGS. 2A, 2B, 2C, and 2D are partial side cross-sectional views of prior art wheel end assemblies illustrating four different designs for clutch ring travel limiting couplers;

FIG. 3 is a cut away side perspective view of a wheel end assembly incorporating a first embodiment of the travel limiter of the present disclosure;

FIG. 4A is cut-away perspective view of an integrated wheel end of the present disclosure including a clutch ring and a first embodiment of a travel limiter configured to limit axial movement of the movable clutch ring shown in the engaged position;

FIG. 4B is a view identical to FIG. 4A, with the movable clutch ring removed;

FIG. 5A is a perspective view of a travel limiter ring embodiment of the present disclosure, as used in the wheel end of FIG. 3;

FIG. 5B is a perspective view of a travel limiter circlip embodiment of the present disclosure;

FIGS. 6A and 6B are cross-sectional views of two exemplary embodiments of the travel limiter of FIG. 5A;

FIGS. 7A and 7B are cross-sectional side views of the top and bottom, respectively, of one exemplary embodiment of a wheel end assembly with a travel limiter according to one exemplary embodiment according to FIG. 3;

FIG. 8 is a cut away side perspective view of a wheel end assembly incorporating a second embodiment of the travel limiter of the present disclosure;

FIG. 9A is cut-away perspective view of an integrated wheel end of the present disclosure including a clutch ring and the travel limiter of FIG. 8 configured to limit axial movement of the movable clutch ring shown in the engaged position;

FIG. 9B is a view identical to FIG. 9A, with the movable clutch ring removed.

FIGS. 10A and 10B are perspective views of two exemplary embodiments of the travel limiter used in the wheel end of FIG. 8;

FIGS. 11A, 11B, and 11C are cross-sectional views of three variations of the exemplary embodiment of the travel limiter of FIG. 9A;

FIGS. 12A and 12B are cross-sectional side views of the top and bottom, respectively, of one exemplary embodiment of a wheel end assembly with a travel limiter according to one exemplary embodiment according to FIG. 8;

FIG. 13 is a cut away side perspective view of a wheel end assembly incorporating a third exemplary embodiment of the travel limiter of the present disclosure;

FIG. 14A is cut-away perspective view of an integrated wheel end of the present disclosure including a clutch ring and a the travel limiter of FIG. 13 configured to limit axial movement of the movable clutch ring shown in the engaged position;

FIG. 14B is a view identical to FIG. 14A, with the movable clutch ring removed;

FIGS. 15A and 15B are side perspective views of exemplary embodiments of the travel limiter shown in the wheel end of FIG. 13;

FIG. 16 is a cross-sectional view of an exemplary embodiment of the travel limiter of FIG. 15A;

FIGS. 17A and 17B are end perspective views of the mating of a clutch ring with a coupler and a travel limiter having internal teeth to engage the teeth of the coupler according to some exemplary embodiments; and

FIGS. 18A and 18B are cross-sectional side views of the top and bottom, respectively, of one exemplary embodiment of a wheel end assembly with a travel limiter according to one exemplary embodiment according to FIG. 13.

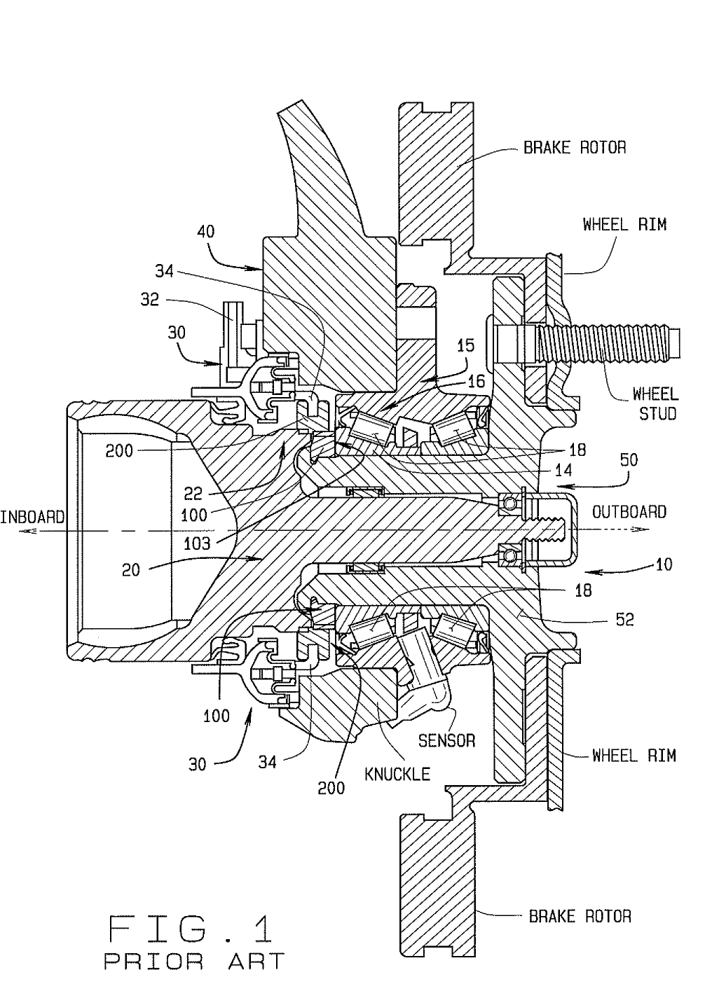

Corresponding reference numerals indicate corresponding parts throughout the several figures of the drawings. It is to be understood that the drawings are for illustrating the concepts set forth in the present disclosure and are not to scale.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

As will be explained below in greater detail with reference to the figures, the present disclosure sets forth an axial travel limiter 300 adapted for use with a coupler 100 of an integrated wheel end 10 configured to selectively engage and disengage a driven drive shaft. The primary function of the travel limiter 300 is to limit or restrict outboard axial travel of the clutch ring 200 when engaging the coupler 100 of the integrated wheel end. The travel limiter 300, in the various embodiments described herein, provides a positive physical stop which engages the outboard surfaces of the clutch ring 200 at the selected limit of axial travel, preventing further movement of the clutch ring 200 in the outboard direction relative to the coupler 100. Exemplary embodiments of the wheel end 10 incorporating the various travel limiters 300 of the present invention are presented in the figures.

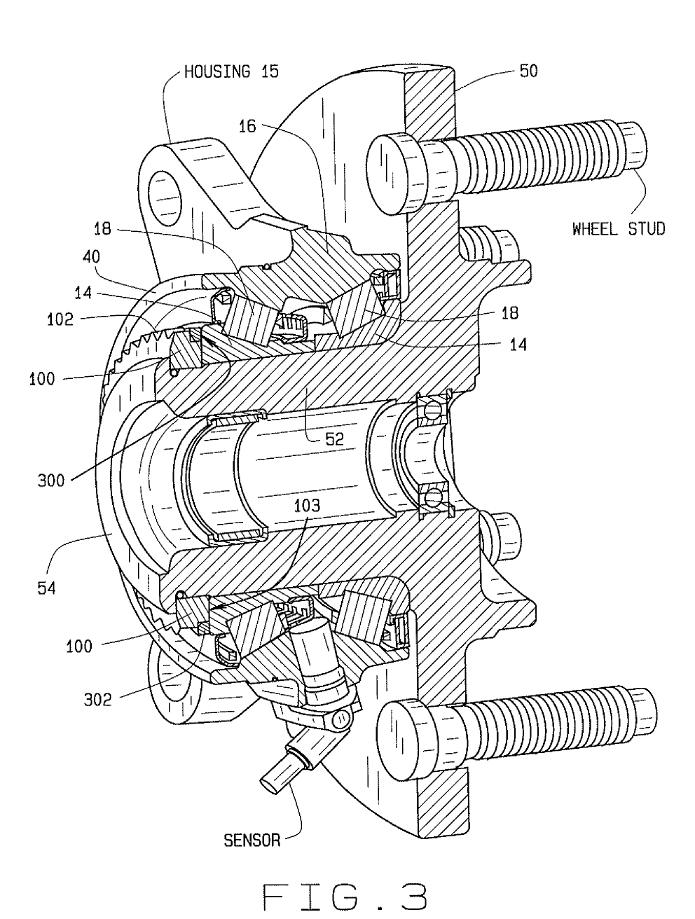

Turning first to FIGS. 3 through 7B, and to FIG. 3 in particular, a wheel end assembly is shown at 10 which includes a wheel hub 50 with a spindle portion 52 supporting an inner race 14 of a bearing assembly. A housing 15 defines an outer race 16 of the bearing assembly, with rolling elements 18 positioned between the two raceways defined by the two races 14, 16. A coupler 100 having an outboard end or face 103 is positioned adjacent to a front (inboard) face of the inner race 14, engaged with the spindle 52. The coupler 100 has external splines 102 configured for meshing with a mating clutch ring 200 having inner splines 202 during selective engagement with a drive shaft. The coupler 100 may be held in place during manufacturing by roll forming an end 54 of the spindle 52 to form a flange, or by any other conventional means.

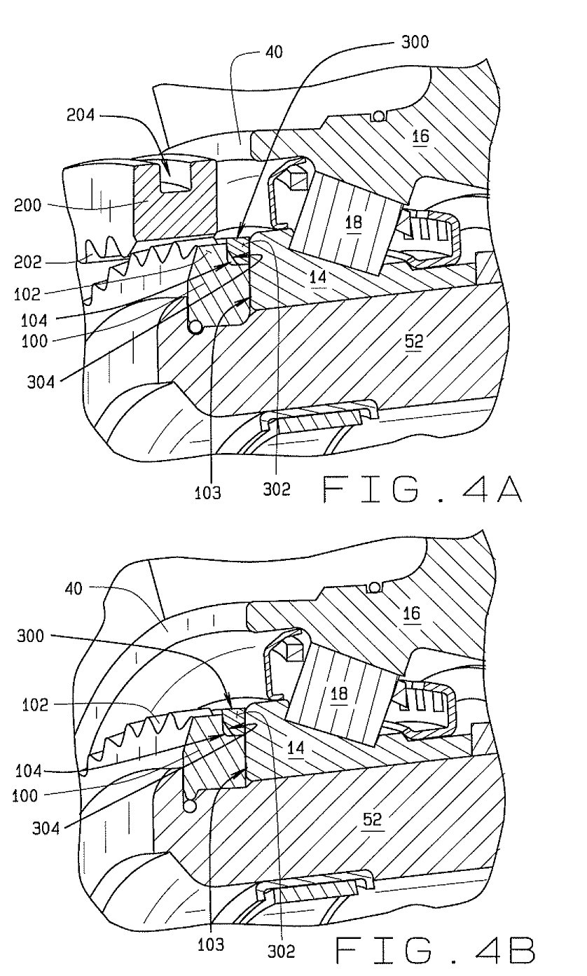

As shown in more detail in FIGS. 4A, 4B, 7A and 7B, the coupler 100 includes an annular groove 104 formed about the circumference of the outboard end or face 103 of the coupler 100. The annular groove 104 can be of any shape, and can have a shape other than rectangular as shown. The annular groove 104 can be formed after the external splines 102 of the coupler 100 are formed, such as by cutting or grinding away a portion of the external splines 102, or by molding or otherwise during formation of the coupler 100. Essentially, the annular groove 104 provides a recessed portion in the outboard face of the coupler 100, adjacent to the inner race 14, and reduces the axial width of the external splines 102. In the embodiment shown in FIGS. 3 through 7B, the axial dimension of the annular groove 104 is selected to define the outboard limit of axial travel for the clutch ring 200 when engaging the coupler 100.

To provide a positive stop to the clutch ring 200 at the selected limit of axial travel, a travel limiter 300 is positioned, at least partially, and in some embodiments, substantially, within the annular groove 104. The outer diameter of the travel limiter 300 is at least greater than the diameter defined by the valleys of the coupler external splines 102, such that the travel limiter 300 occludes the outboard end of each external spline valley.

In some embodiments, as shown in the figures, the travel limiter 300 has an outer diameter that is substantially equal to the outer diameter of the coupler 100 as defined by the peaks of the coupler external splines 102, but in others the outer diameter of the travel limiter 300 is greater than or less than the outer diameter of the coupler 100. An outboard face or end of the travel limiter 300 is configured to abut the front face of the inner race 14, and is generally coplanar with the outboard face of the coupler 100.

Generally, the travel limiter 300 has an annular body 302 with an axial width that is less than an axial width of the coupler 100. The body 302 can be of a variety of shapes and sizes, and by way of examples, can be a solid annular shaped body 302A or a split body 302B such as a circlip configured for compressive engagement about the coupler 100. Other shapes are also possible. If the travel limiter 300 has a solid annular rigid body 302A, the travel limiter 300 can be assembled onto the coupler 100 prior to the coupler 100 being assembled to the wheel end 10. However, if it is a split travel limiter body 302B, the coupler 100 may optionally be assembled to the wheel end 10 first, and then the travel limiter 300 could be expanded to fit over the coupler external splines 102 and spring back to fit onto the coupler 100 such as within an annular groove 104 or about the coupler external splines 102. The travel limiter 300 can be composed of any material including plastics, metals and composites.

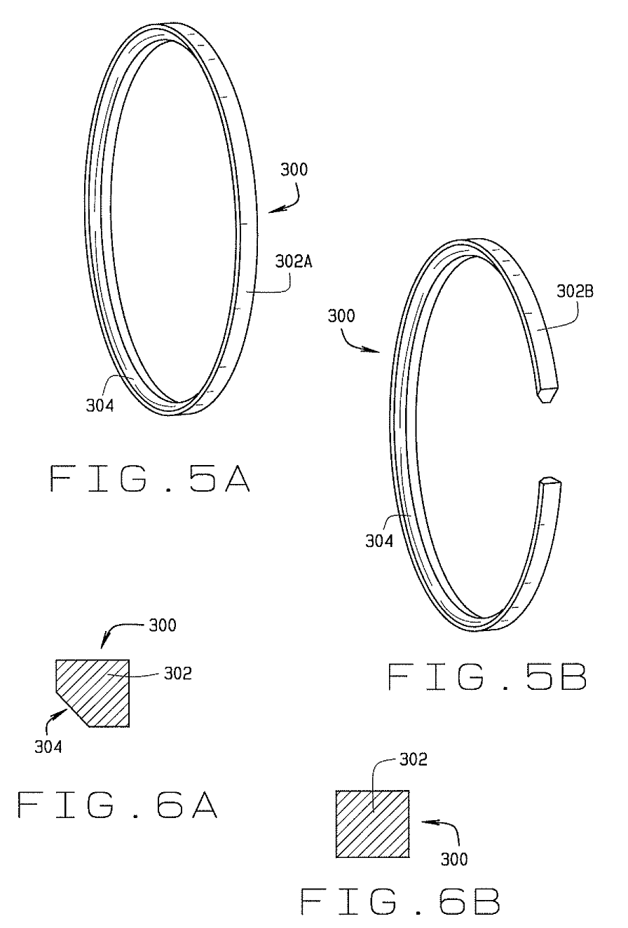

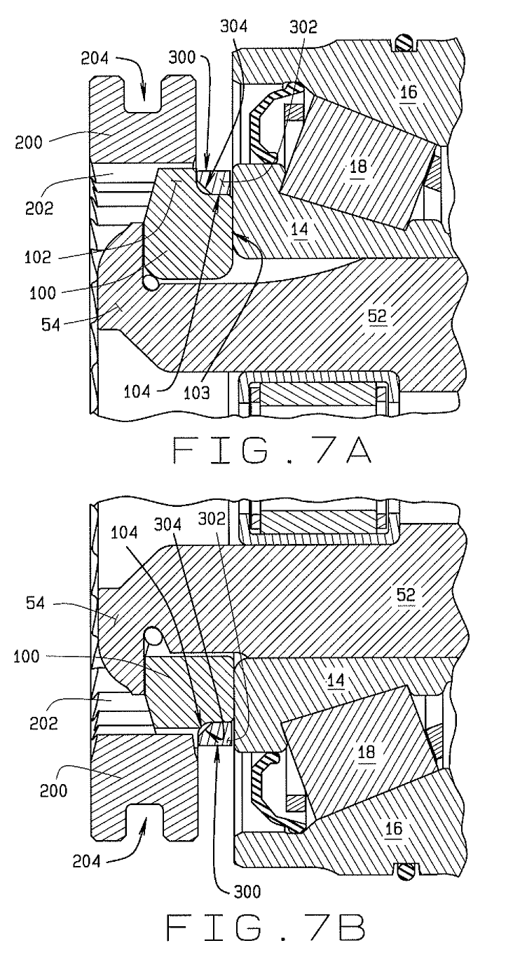

As shown in FIGS. 5A, 5B, and 6A and 6B, the travel limiter 300 can have one or more beveled edges 304 to aid in the assembly or installation of the travel limiter 300 onto the coupler 100, and into the annular groove 104. A beveled or shaped edge 304 can provide for improved clearance with the coupler annular groove 104 inner radius and as such can be much smaller if used with a smaller coupler radius. Alternatively, the beveled edge 304 could have multiple angles or could be curved. Additionally, the cross sectional area of the body 302 of the travel limiter 300 can have other shapes including a rectangular or square shape.

During assembly of the wheel end 10, the travel limiter 300 is seated within the groove 104 of the coupler 100 either before or after the coupler 100 is assembled onto the spindle 52. The travel limiter 300 is positioned within the groove 104 such that the outboard end or face is positioned or positionable adjacent the front face of the inner race 14. When the wheel end 10 is assembled, the clutch ring internal splines 202 mate with the external splines 102 of the coupler 100, and permit axial movement relative thereto. The axial width of the groove 104 in the coupler 100 and the disposed travel limiter 300 function to limit the outboard axial movement of the clutch ring external splines 202 to a predetermined stop along the axis of the wheel end 10 by providing an abutting engagement between the internal splines 202 and the travel limiter 300 inboard surface. In this manner, the clutch ring 200 and coupler 100 are positioned for proper assembly of the wheel end 10.

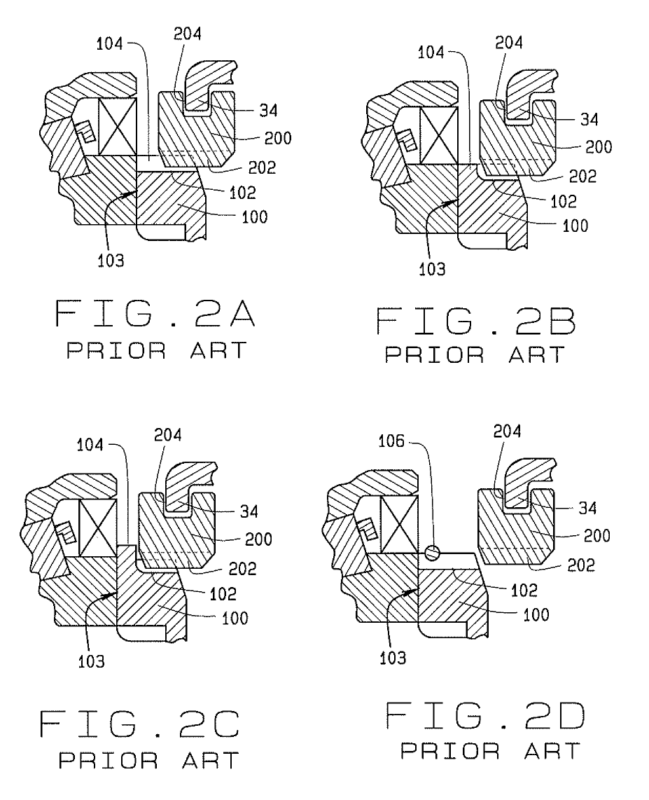

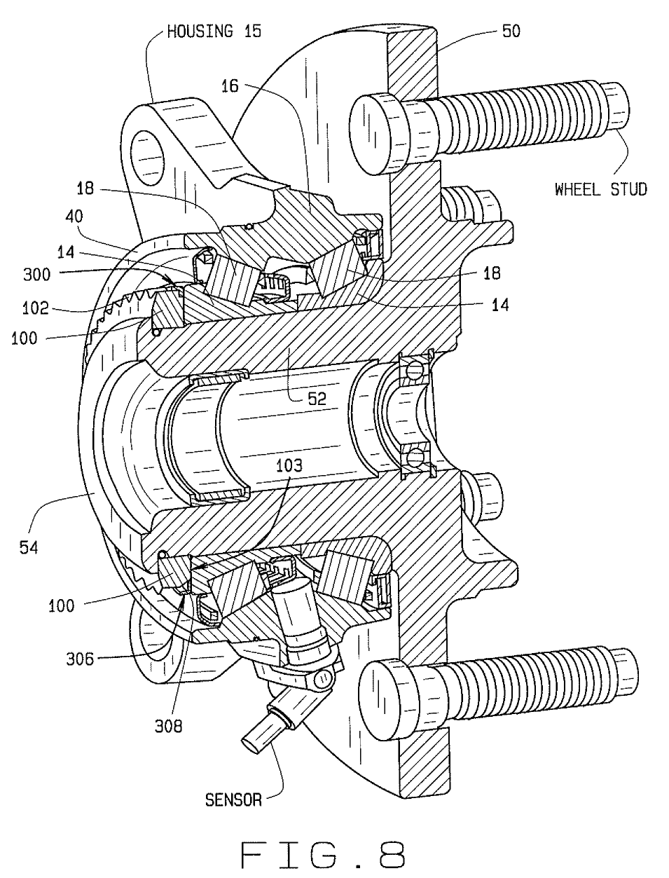

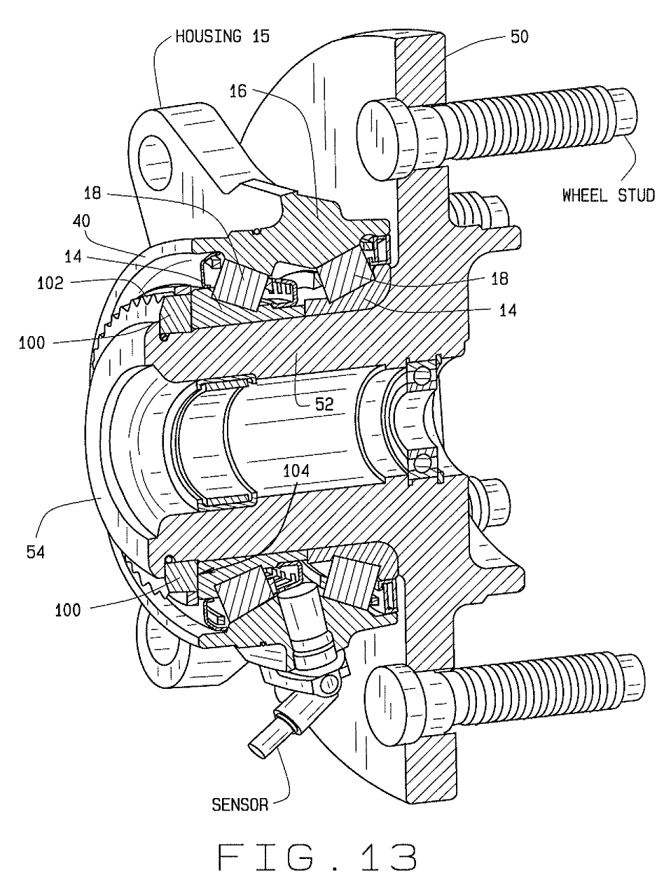

Turning next to FIGS. 8 through 12B, and to FIG. 8 in particular, a variation of the travel limiter 300 is shown with the wheel end assembly 10. As shown in more detail in FIGS. 9A, 9B, 12A and 2B, the coupler 100 includes an annular groove 104 formed about the circumference of the outboard end or face 103 of the coupler 100. The annular groove 104 can be of any shape, and can have a shape other than rectangular as shown. The annular groove 104 can be formed after the external splines 102 of the coupler 100 are formed, such as by cutting or grinding away a portion of the external splines 102, or by molding or otherwise during formation of the coupler 100. Essentially, the annular groove 104 provides a recessed annular portion in the outboard face of the coupler 100, adjacent to the inner race 14, and reduces the axial width of the external splines 102. In the embodiment shown in FIGS. 8 through 12B, the axial dimension of the annular groove 104 is relatively small, and does not define the outboard limit of axial travel for the clutch ring 200 when engaging the coupler 100.

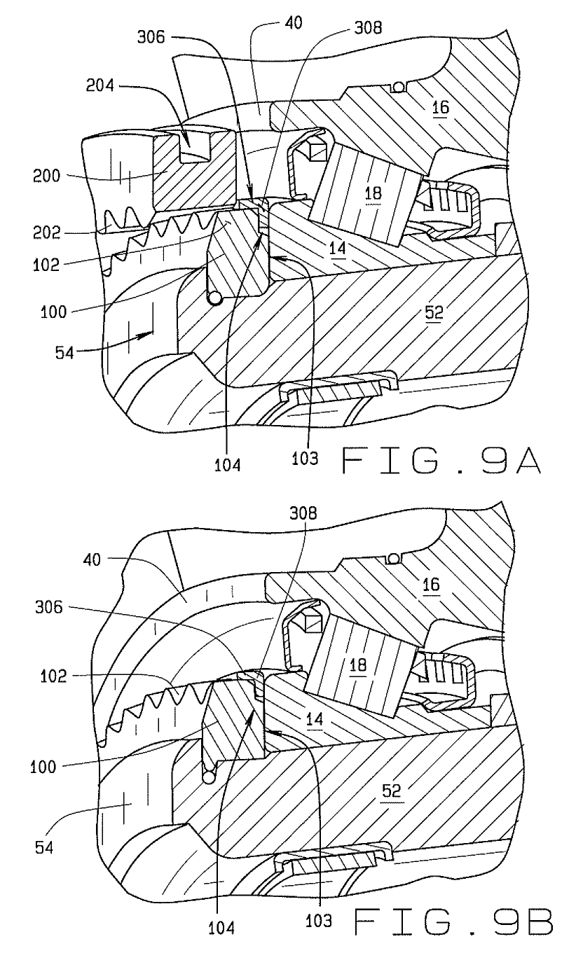

To provide a positive stop to the clutch ring 200 at a selected limit of axial travel, a travel limiter 300 having an L-shaped body 308 is positioned within the annular groove 104. The L-shaped body 308 of the travel limiter 300 is configured for placement with a portion of the body 308 within the annular groove 104, flush with the outboard face 103 of the coupler 100, and with an extension portion 306 of the body 308 extending axially inward along the outer dimension or exterior peaks of the coupler external splines 102. This L-shaped body 308 defines the travel limiter 300 as having two diameters, one large and one narrow. The narrow diameter portion fits over the coupler 100 and seats within the annular recess 104. The large diameter portion of the travel limiter 300 fits or wraps over an axial portion of the external splines 102 of the coupler 100 to define a positive axial stop for the clutch ring 200, as best seen in FIG. 9A.

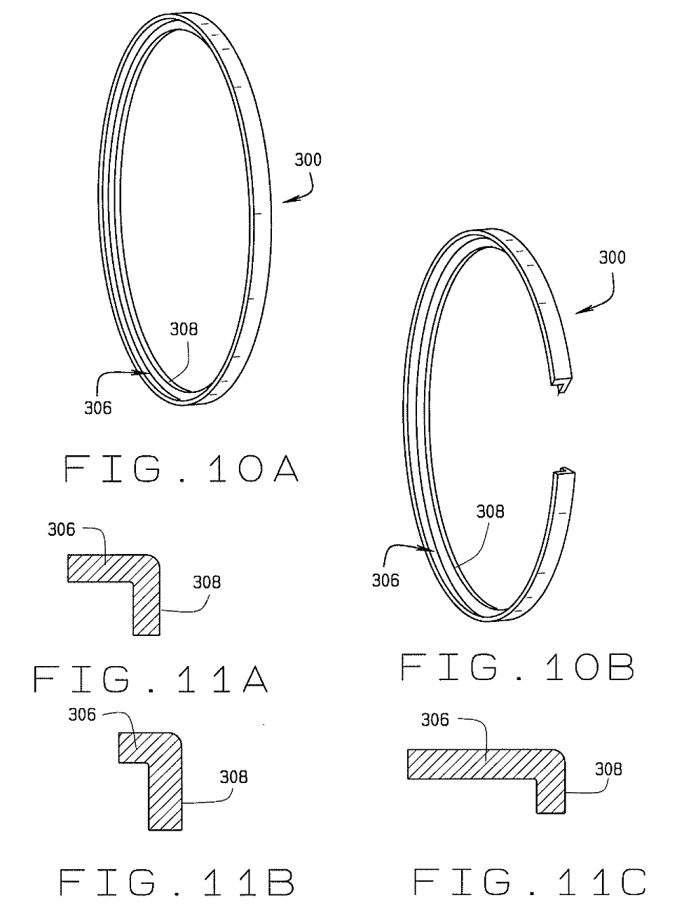

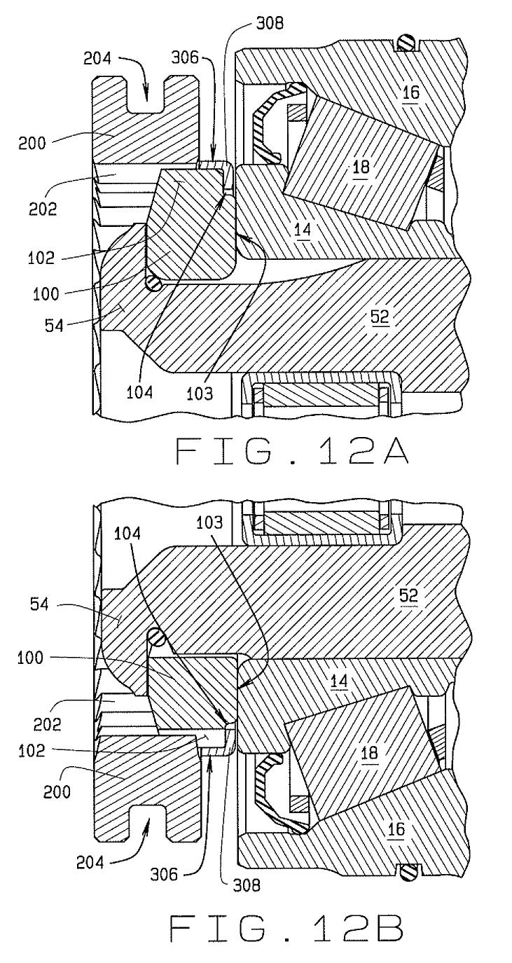

The body 308 of the travel limiter 300 can have a variety of L-shaped extensions 306, as shown in FIGS. 11A, 11B, and 11C, with the axial width of the L-shaped extension 306 selected to define the limit of axial travel permitted for the clutch ring 200 relative to the coupler 100 once the travel limiter 300 is installed in the annular groove 104. Additionally, the travel limiter 300 can be an annular ring or a circlip as shown in FIGS. 10A and 10B. It should also be noted that while the exemplary figures show an annular solid body 308, one or more extensions of the L-shaped body 308 of the travel limiter 300 can be broken such that only a portion of the body 308 extends into the annular groove 104 and/or only a portion of the extension 306 extends above and about the peaks of the coupler external splines 102.

During assembly of the wheel end 10, the travel limiter 300 is seated within the groove 104 of the coupler 100 either before or after the coupler 100 is assembled onto the spindle 52. The travel limiter 300 is positioned within the groove 104 such that the outboard end or face is positioned or positionable next to the front face of the inner race 14. When the wheel end 10 is assembled, the clutch ring internal splines 202 mate with the external splines 102 of the coupler 100, and permit axial movement relative thereto. The axial depth of the groove 104 in the coupler 100 and the axial extension 306 of the L-shaped body 308 of the disposed travel limiter 300 limit the outboard axial movement of the clutch ring external splines 202 to a predetermined stop along the axis of the wheel end 10 by providing an abutting engagement between the internal splines 202 and the inboard face of the travel limiter 300 axial extension 306. In this manner, the clutch ring 200 and coupler 100 are positioned for proper assembly of the wheel end 10.

In an alternate embodiment of the travel limiter 300, instead of a portion of the travel limiter 300 extending above and/or axially along the peaks of the coupler external splines 102, a portion of the body 302 or 308 of the travel limiter 300 which is not disposed within the annular groove 104 can alternatively extend axially into a portion of the valleys of the coupler external splines 102 to therein engage the peaks of the clutch ring internal splines 202 and limit axial travel of the clutch ring 200 to a desired position. For example, the extension 306 of the L-shaped body 308 of the travel limiter 300 can incorporate projections, protrusions or teeth 310 that are partially engaged with or extending along, the wheel axis into the coupler external splines 102.

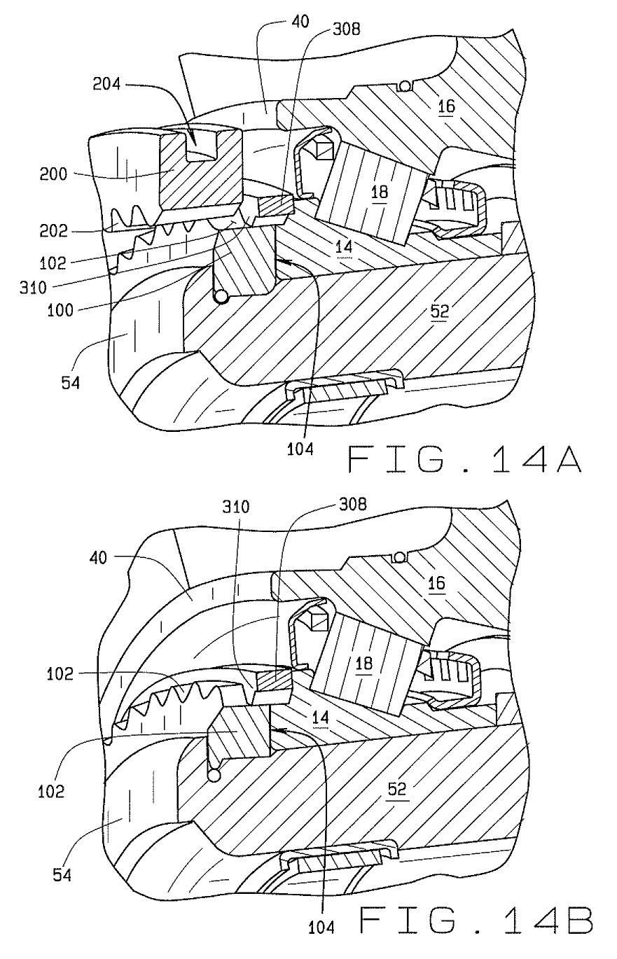

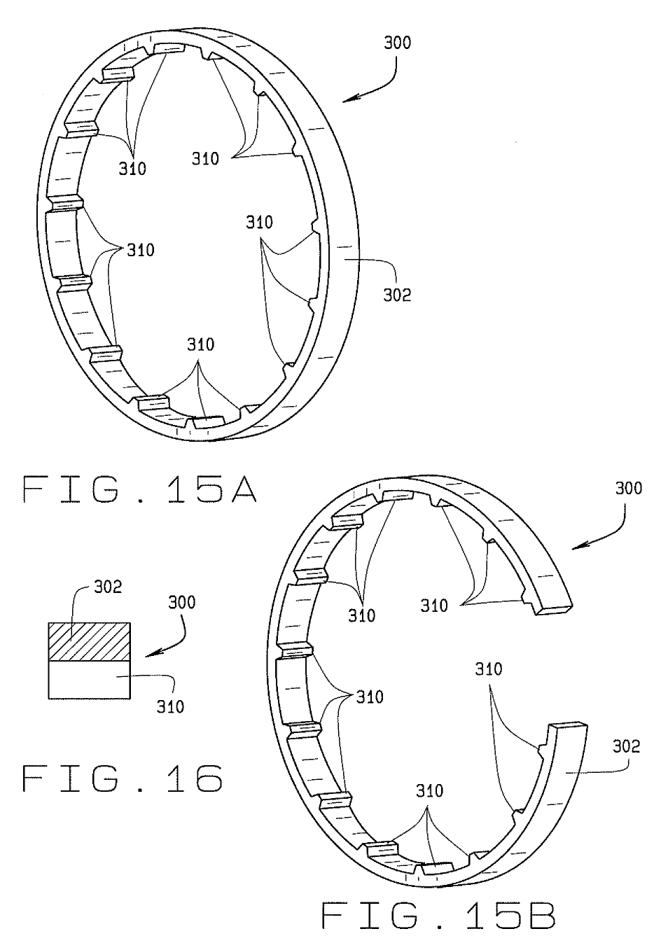

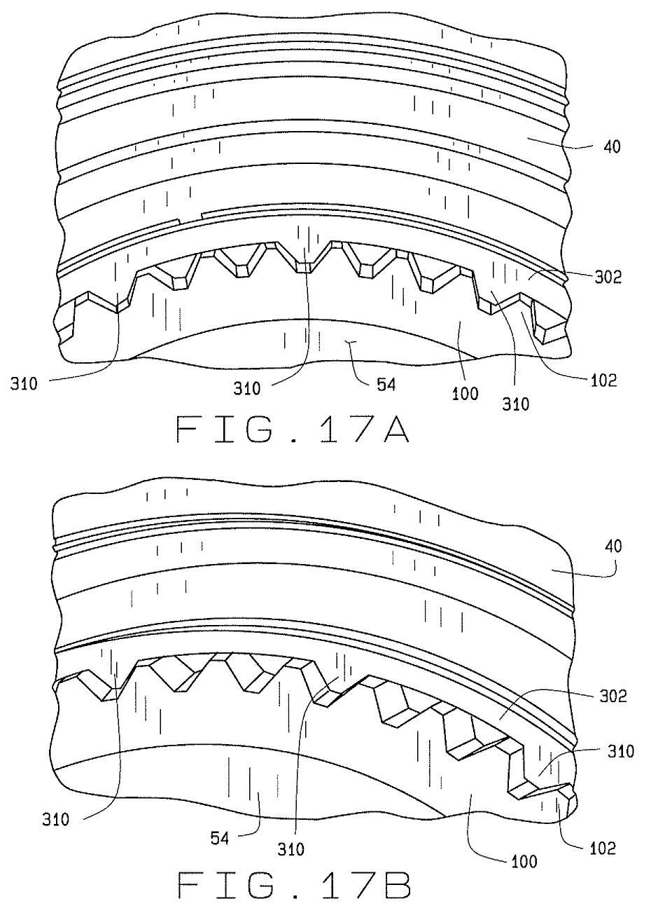

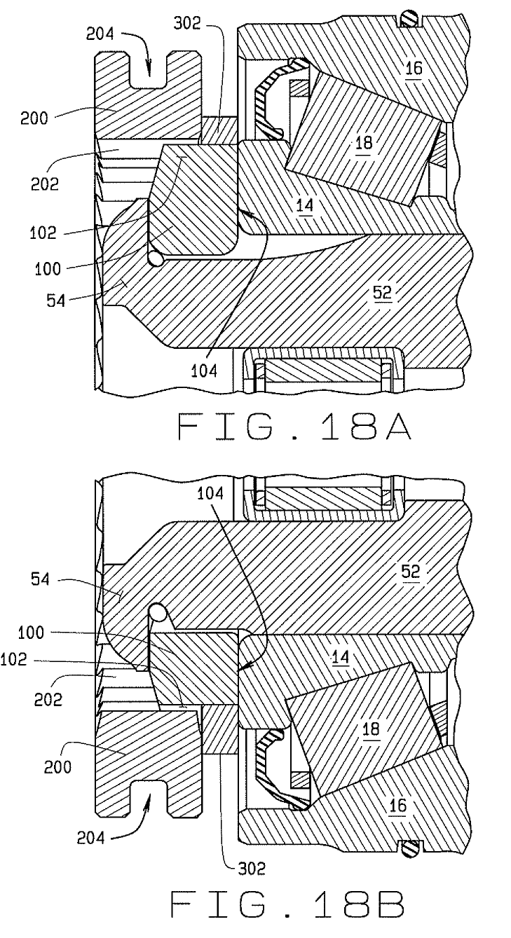

By extending projections, protrusions, or teeth 310 into some or all of the valleys between the external splines 102 of the coupler 100, a travel limiter 300 may be utilized with a coupler 100 which does not incorporate an annular groove 103 in the outboard face 103. For example, in the embodiments shown in FIG. 13 through FIG. 18B, the travel limiter 300 can be dimensioned and configured such that inward projections or teeth 310 prevent the travel limiter 300 from sliding in an outboard direction over the outer diameter of the inner race 14, thereby supporting the axial loading on the travel limiter 300 from the clutch ring 200 such as during an assembly process. The travel limiter 300 can either be press fitted to the coupler outer diameter, or be press fitted by the sides of the external splines, or both. The external splines 102 engage with the teeth 310, and facilitate retention of the travel limiter 300 in position, both axially and rotationally.

With the embodiment shown in FIG. 13 through FIG. 18B, the coupler 100 does not utilize an annular groove 104 for receiving the travel limiter 300. Rather, the travel limiter 300 is configured and dimensioned for positioning about the peaks of the external splines 102 of the coupler 100 and for positioning between the outboard face of the clutch ring 200 and the front or inboard face of the inner race 14.

In some of these embodiments the travel limiter 300 does not require the inward projections or teeth 310. In such cases, the travel limiter 300 can be held by a press fit onto the peaks of the coupler external splines 102. In this design, the travel limiter can be assembled to the coupler 100 and the wheel end 10 or bearing assembly at any point in the manufacturing process, either before bearing assembly, during bearing assembly, during wheel end assembly, or during final assembly on the vehicle. Additionally, if desired, travel limiter 300 can be pressed into place and against the front face of the inner race 14 during assembly of the clutch ring 200 onto the coupler 100 and/or assembly of the axle shaft with the clutch ring 200.

Generally, travel limiters 300 and couplers 100 as described herein can provide for improved assembly of an integrated wheel end 10 which is adapted to selectively engage a drive shaft via an axially displaceable clutch ring 200 having internal splines 202 for engaging external splines 102 of the coupler 100. During assembly of the integrated wheel end 10, the travel limiter 300 is installed onto the coupler 100 either before or after the coupler 100 is installed on the spindle 52 of the wheel hub 50. The clutch ring 200 is installed on the housing assembly, that is then assembled onto the wheel end assembly 10 so that the clutch ring external splines 202 engage or couple with the coupler external splines 102. Finally, the axle shaft is installed so that external splines of the axle shaft additionally engage the internal splines 202 of the clutch ring 200. During such engagement, the shaft and its splines push the clutch ring 200 axially further into the wheel end assembly 10 in an outboard direction, such that the clutch ring internal splines 202 are pushed further onto the coupler external splines 102. However, the travel limiter 300 functions to limit the outboard axial movement of the clutch ring 200 onto the coupler 100 to a predetermined or defined distance from the outboard end of the coupler 100 and the front face of the inner race 14 of the bearing assembly. The travel limit is provided by the travel limiter 300 in combination with a standard coupler 100 that may have an annular groove 104 along its outboard end or face for receiving the travel limiter 300. This combination can provide for an improved assembly of the wheel end 10 at minimum complexity and costs.

As various changes could be made in the above constructions without departing from the scope of the disclosure, it is intended that all matter contained in the above description or shown in the accompanying drawings shall be interpreted as illustrative and not in a limiting sense.

1. A travel limiter for use with a wheel end having an actuator, a clutch ring having internal splines engaged with external splines of a drive axle and axially moveable in response to the actuator, a coupler supported by a bearing assembly including an inner race, an outer race, and a rolling element and having an inboard end for engagement with the clutch ring and an outboard end, wherein the coupler includes external splines engaged with the internal splines of the clutch ring for selective engagement between an engaged and disengaged position for transferring driving torque from the drive axle to the wheel end, comprising:
an annular body adapted for circumferential engagement with an outer diameter of the coupler, said annular body having an axial width less than an axial width of the coupler and an outboard face configured for substantially aligning with an outboard end of the coupler and for abutting a front face of the inner race; and
wherein said annular body is axially dimensioned to limit the outboard axial travel of the clutch ring relative to the coupler and towards the inner race.

2. The travel limiter of claim 1 wherein the annular body is discontinuous, defining a circlip configured for compressive engagement about a diameter of the coupler.

3. The travel limiter of claim 1 wherein the coupler further includes an annular groove adjacent an outboard face, and wherein said annular body is configured for engagement with the coupler at said annular groove.

4. The travel limiter of claim 1 wherein the annular body has an axial width dimensioned to ensure that the outboard face of the annular body abuts against the front (inboard) face of the inner race and the clutch ring abuts against the travel limiter annular body before or simultaneous with an abutment of the actuator with a support structure of the wheel end.

5. The travel limiter of claim 1 wherein at least a portion of the annular body seats within the external splines of the coupler.

6. The travel limiter of claim 1 wherein at least one circumferential surface of the annular body is beveled to facilitate engagement with the coupler.

7. The travel limiter of claim 1 wherein the annular body has an outer diameter that is substantially equal to an outer diameter of the coupler.

8. The travel limiter of claim 9 wherein the annular body has an outer diameter that exceeds an outer diameter of the coupler.

9. The travel limiter of claim 8 wherein the annular body includes an axially extending flange configured for overlapping an axial portion of the external splines of the coupler adjacent to an outboard face of the coupler.

10. The travel limiter of claim 9 wherein said annular body has a substantially L-shaped cross-sectional area.

11. The travel limiter of claim 1 wherein the annular body has an inner diameter substantially equal to the outer diameter of the coupler, and wherein the travel limiter is configured for assembly onto the external splines of the coupler.

12. The travel limiter of claim 1 wherein the annular body is configured for positioning substantially about the outer circumference of the external splines of the coupler, the annular body further including at least one radially inward protrusion configured to seat between and engage the external splines of the coupler.

13. A wheel end assembly having a drive axle with external teeth, a clutch ring having internal splines configured for sliding engagement with external splines of the drive axle, and a bearing assembly including an inner race, an outer race, and a rolling element, comprising:
a coupler associated with the inner race, having an inboard end for external engagement with the internal splines of the clutch ring and an outboard end for abutment with a front face of the inner race, the coupler having external splines about an outer periphery; and
a travel limiter positioned about the outboard end of the coupler and having an outboard face substantially aligned with the outboard end of the coupler and abutting a front face of the inner race.

14. The wheel end assembly of claim 13 wherein the coupler is disposed on an inboard portion of a wheel hub spindle rotatably supported by the bearing assembly, said coupler further disposed adjacent to the drive axle and wherein the external splines of the coupler align with the external splines of the drive axle for selective sliding engagement simultaneously with the internal splines of the clutch ring.

15. The wheel end assembly of claim 13 wherein the travel limiter is configured to limit axial travel of the clutch ring relative to the coupler during engagement of the clutch ring internal splines with the external splines of the drive axle and the coupler.

16. The wheel end assembly of claim 13 wherein the travel limiter is configured to axially position the movable clutch ring at a predetermined position relative to the coupler during assembly of the wheel end with the drive axle.

17. The wheel end assembly of claim 13 wherein the travel limiter has a body configuration selected from either an annular body configuration or a circlip body configuration.

18. The wheel end assembly of claim 13 wherein the travel limiter is press fitted onto the coupler.

19. The wheel end assembly of claim 13 wherein a diameter about the outboard end of the coupler is less than the outer diameter defined by the external splines, and wherein the outer diameter defined by the external splines extends from the inboard end and less than an entire axial width of coupler, thereby forming an annular valley at the outboard end; and
wherein the travel limiter is positioned about the outboard end of the coupler at least partially within the annular valley adjacent to the outboard end.

20. The wheel end assembly of claim 19 wherein the travel limiter has an outer diameter that is substantially equal to the outer diameter of the coupler as defined by the coupler external splines.

21. The wheel end assembly of claim 19 wherein the travel limiter has an outer diameter that exceeds the outer diameter of the coupler as defined by the coupler external splines.

22. The wheel end assembly of claim 19 wherein the travel limiter includes a axial extension flange configured for overlapping a portion of the axial length of the external splines adjacent to the annular valley; and
wherein the travel limiter has an annular body with a substantially L-shaped cross-sectional area.

23. The wheel end assembly of claim 13 wherein the external splines of the coupler extend axially across an entire axial width of the coupler; and
wherein the travel limiter is configured for installation directly onto the external splines of the coupler.

24. The wheel end assembly of claim 23 wherein the travel limiter has an inner diameter substantially equal to the outer diameter of the coupler external splines.

25. The wheel end assembly of claim 23 wherein the travel limiter is configured for positioning substantially about the outer circumference of the coupler external splines; and wherein the travel limiter includes at least one radially inward protrusion dimensioned for insertion between two of the coupler external splines.

26. The wheel end assembly of claim 25 wherein the travel limiter includes a plurality of said radially inward protrusions spaced apart around an interior periphery of the body, each of said protrusions dimensioned for insertion between two of the coupler external splines.
